(19) United States
(12) Patent Application Publication
(10) Pub. No.: US 2009/0305682 A1
(43) Pub. Date: Dec. 10, 2009

(54) SYSTEM AND METHOD FOR WEBPAGE DISPLAY IN A PORTABLE ELECTRONIC DEVICE

(76) Inventor: Karin Spalink, Durham, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/135,381

(22) Filed: Jun. 9, 2008

(51) Int. Cl. H04L 29/06; H04M 1/00

(52) U.S. Cl. 455/414.3; 455/566

(57) ABSTRACT

An improved system and method for displaying webpage content on a portable electronic device is provided. An entire webpage may be displayed in a display of the portable electronic device. Layout parameters may define a plurality of focus areas of content portions within the webpage. A user may select a focus area, and display settings may be applied to the focus area to provide an enhanced display of the focus area. In addition, the system may store the layout parameters and display settings for future application. When a user accesses a previously accessed webpage, or one similar to a previously accessed webpage, the stored layout parameters and display settings may be applied automatically. In this manner, an enhanced display of webpage content is provided with minimal user effort.

### TECHNICAL FIELD OF THE INVENTION

The technology of the present disclosure relates generally to portable electronic devices, and more particularly to a system and method for enhanced webpage display in a portable electronic device.

### DESCRIPTION OF THE RELATED ART

Portable electronic devices, such as mobile telephones, media players, personal digital assistants (PDAs), and others, are ever increasing in popularity. To avoid having to carry multiple devices, portable electronic devices are now being configured to provide a wide variety of functions. For example, a mobile telephone may no longer be used simply to make and receive telephone calls. A mobile telephone may also be a camera, an Internet browser for accessing news and information, an audiovisual media player, a messaging device (text, audio, and/or visual messages), a gaming device, a personal organizer, and have other functions as well.

To enhance portability, portable electronic devices have tended to decrease in size over the development of the applicable technology. Although beneficial in many respects, the small size of portable electronic devices limits the typical display size. In particular, when a portable electronic device is used for Internet browsing and the like, webpages and related content may be difficult to read.

As is known in the art, conventional webpages may possess a variety of content, including text, symbols, images, audio etc. In addition, content items may be selectable to provide links to additional content concerning the selected item, and/or provide links to other webpages for access to additional content. For electronic devices having relatively large displays, such as desktop or laptop computers, webpage content is fairly easy to view and navigate. For portable electronic devices, such as mobile telephones for example, the limited display size reduces the convenience and usefulness of webpage content. Webpage text may be difficult to read, and images and symbols similarly may be difficult to decipher and navigate.

There have been attempts to improve the visibility of webpage content on portable electronic devices. Many such attempts involve truncating the webpage content. For example, webpages may be converted to text-only versions, thereby permitting more readable text because the image content is not displayed. Text-only systems may permit altering the font to enhance readability. Typically, such display settings may apply only to the currently displayed content and revert back to conventional display or default settings when a user navigates to another webpage. The need to manipulate the display as the user navigates over various webpages is a source of inconvenience. Other methods of displaying webpage content on portable electronic devices may include displaying only portions of the webpage at a time, combined with scrolling features to access non-displayed portions. These and other methods that provide for truncated content have proven deficient in that a user cannot access the entirety of the content at once. Usefulness and enjoyment are therefore reduced.

### SUMMARY

To improve the consumer experience with portable electronic devices, there is a need in the art for an improved system and method for displaying webpage content on a portable electronic device. In embodiments of the present invention, an entire webpage may be displayed in a display of the portable electronic device. Layout parameters may define a plurality of focus areas of content portions within the webpage. A user may then select a focus area, and display settings may be applied to the focus area to provide an enhanced display of the focus area. For example, the display settings may include increasing the font of text in the focus area, enlarging the focus area, enlarging images contained in the focus area, highlighting the focus area within the webpage, and the like to enhance the visibility of the focus area. Multiple settings may be applied to the focus area in combination. In addition, the system may store the layout parameters and display settings for future application. When a user accesses a previously accessed webpage, or one similar to a previously accessed webpage, the stored layout parameters and display settings may be applied automatically. In this manner, an enhanced display of webpage content is provided with minimal user effort.

Therefore, according to one aspect of the invention, an electronic device comprises a browser for accessing content, a display for displaying the content, a controller for generating a plurality of focus areas within the content, each focus area comprising a portion of the content, and an input device for receiving a selection of a focus area from among the plurality of focus areas. The controller is further configured to receive the selection from the input device and alter the display of the selected focus area.

According to one embodiment of the electronic device, the content includes a plurality of layout parameters, and the controller is configured to generate the plurality of focus areas from the layout parameters of the content.

According to one embodiment of the electronic device, the input device receives an input of at least one display setting, and the controller is configured to alter the display of the selected focus area in accordance with the inputted display setting.

According to one embodiment of the electronic device, the at least one display setting is at least one of highlighting the focus area, enlarging the focus area, altering the font of text within the focus area, enlarging an image within the focus area, adjusting the volume of audio content within the focus area, and conveying audio content within the focus area in a text-to-speech format.

According to one embodiment of the electronic device, the electronic device further comprises a memory for storing the plurality of layout parameters and the at least one display setting.

According to one embodiment of the electronic device, the content is a first content and the browser accesses a second content. The controller is further configured to determine whether the second content substantially matches the first content, and if so, apply the stored layout parameters and stored at least one display setting to the second content.

According to one embodiment of the electronic device, the plurality of the layout parameters are embedded in the content as accessed by the browser, and the controller is configured to generate the plurality of focus areas by extracting the layout parameters from the content.

According to one embodiment of the electronic device, the controller is configured to define the plurality of layout parameters from the configuration of the content, and to generate the plurality of focus areas from the defined layout parameters.

According to one embodiment of the electronic device, the controller is configured to define the layout parameters from white spaces that separate portions of the content.

According to one embodiment of the electronic device, the input device receives inputs from a user defining the plurality of layout parameters, and the controller is configured to generate the plurality of focus areas from the inputted layout parameters.

According to one embodiment of the electronic device, the controller is configured to alter the display of the selected focus area by at least one of highlighting the focus area, enlarging the focus area, altering the font of text within the focus area, enlarging an image within the focus area, adjusting the volume of audio content within the focus area, and conveying audio content within the focus area in a text-to-speech format.

According to one embodiment of the electronic device, the electronic device is a mobile telephone.

According to another aspect of the invention, a method of displaying content in an electronic device comprises the steps of accessing content, displaying the accessed content on a display, generating a plurality of focus areas within the content, wherein each focus area comprises a portion of the content, receiving a selection of a focus area from among the plurality of focus areas, and altering the display of the selected focus area.

According to one embodiment of the method, the altering step comprises at least one of highlighting the focus area, enlarging the focus area, altering the font of text within the focus area, enlarging an image within the focus area, adjusting the volume of audio content within the focus area, and conveying audio content within the focus area in a text-to-speech format.

According to one embodiment of the method, the generating step comprises defining a plurality of layout parameters within the content, and generating the plurality of focus areas from the layout parameters.

According to one embodiment of the method, the altering step includes receiving an input of at least one display setting from an input device, and altering the display of the selected focus area in accordance with the inputted display setting.

According to one embodiment of the method, the method further comprises storing the plurality of layout parameters and storing the at least one display setting in a memory.

According to one embodiment of the method, the content is a first content, and the method further comprises accessing a second content, determining whether the second content substantially matches the first content, and if so, applying the stored layout parameters and stored at least one display setting to the second content.

According to one embodiment of the method, the plurality of the layout parameters are embedded in the accessed content, and the generating step comprises extracting the layout parameters from the content and generating the plurality of focus areas from the extracted layout parameters.

According to one embodiment of the method, the generating step comprises defining a plurality of layout parameters from white spaces separating portions of the content, and generating the plurality of focus areas from the defined layout parameters.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic view of a mobile telephone as an exemplary electronic device for use in accordance with an embodiment of the present invention.

FIG. 2 is a schematic block diagram of operative portions of the mobile telephone of FIG. 1.

FIG. 3 is a schematic diagram of a communications system in which the mobile telephone of FIG. 1 may operate.

FIG. 4 is a schematic diagram of operative portions of an exemplary content server that may be used in accordance with an embodiment of the present invention.

FIG. 5 is a flowchart depicting an exemplary method of displaying content in a portable electronic device.

FIGS. 6-7 depict an exemplary webpage as it may be displayed on the mobile telephone of FIG. 1.

FIGS. 8-10 depict an exemplary graphical user interface and menu system for a webpage display application.

FIG. 11 is a flowchart depicting an exemplary method of sequentially displaying multiple content sources in a portable electronic device.

### DETAILED DESCRIPTION OF EMBODIMENTS

A system and methods are provided for the enhanced display of webpage content on a portable electronic device. As used herein, the term “webpage” is meant to include broadly content accessed over the Internet or comparable network by the portable electronic device, as is conventional. The webpage may contain layout parameters, which essentially divide the screen display of the webpage into content portions. The content portions may be related by subject matter, or related based on their relative position in the webpage display. For example, a conventional webpage may be divided in portions of text, images, symbols, network links, and/or combinations thereof. Webpage layout parameters may be extracted from the source code of the webpage and recognized by the portable electronic device. A user may then access a layout-specific area using navigation and selection features of the portable electronic device. A layout-specific area defining a content portion of the webpage is sometimes referred to herein as a “focus area”.

In another embodiment, the layout parameters may not be defined or otherwise retrievable from the webpage content itself. In such a situation, the electronic device may define layout parameters based on the configuration of the content in the webpage. For example, layout parameters may be defined based on white-space delineated areas of the content. Regardless of how the layout parameters are defined, a user may select a particular focus area for enhanced display. A user may then define display settings for the enhanced display of the focus area, which may include such settings as enlarging the focus area, enlarging the font of text in the focus area, highlighting the focus area, and the like. It will be appreciated that various display settings, and combinations thereof, may be employed.

In addition, the layout parameters and display settings may be stored in a memory for future application. When a user accesses a given webpage, pattern matching may be applied to compare the content configuration of the currently accessed webpage to that of previously accessed webpages. If a substantial match is found, the stored layout parameters and display settings may be applied, thereby obviating the need to continually define display settings for frequently accessed webpages or categories of webpages.

Embodiments of the present invention will now be described with reference to the drawings, wherein like reference numerals are used to refer to like elements throughout. It will be understood that the figures are not necessarily to scale.

The following description is made in the context of a conventional mobile telephone. It will be appreciated that the invention is not intended to be limited to the context of a mobile telephone and may relate to any type of appropriate electronic device, examples of which include a media player, a gaming device, or other portable electronic device. For purposes of the description herein, the interchangeable terms “electronic equipment” and “electronic device” also may include portable radio communication equipment. The term “portable radio communication equipment,” which sometimes hereinafter is referred to as a “mobile radio terminal,” includes all equipment such as mobile telephones, pagers, communicators, electronic organizers, personal digital assistants (PDAs), smartphones, and any communication apparatus or the like.

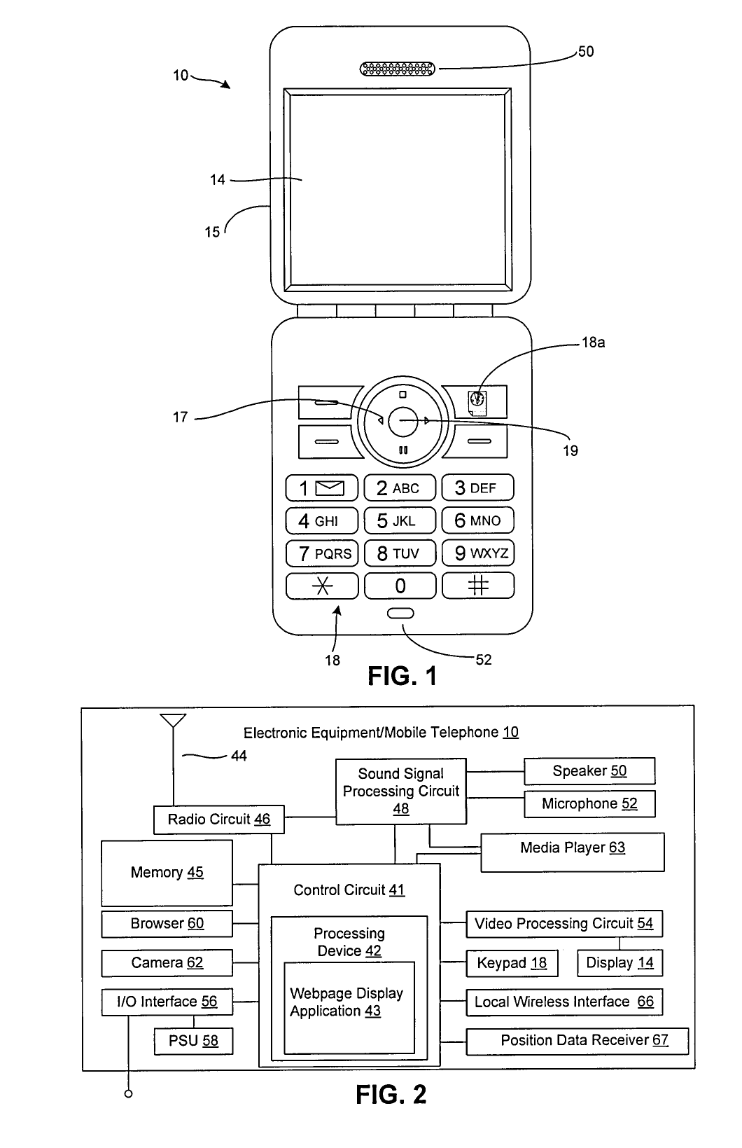

FIG. 1 depicts an exemplary mobile telephone 10. Mobile telephone 10 may be a clamshell phone with a flip-open cover 15 movable between an open and a closed position. In FIG. 1, the cover is shown in the open position. It will be appreciated that mobile telephone 10 may have other configurations, such as a “block” or “brick” configuration, slide or swivel cover configuration, or others.

FIG. 2 represents a functional block diagram of operative portions of the mobile telephone 10. The mobile telephone 10 may include a webpage display application 43 for carrying out the features of the invention. Application 43 may be embodied as executable program code that is resident in and executed by the mobile telephone 10. The mobile telephone 10 may include a controller that executes the program code stored on a computer or machine-readable medium. The controller may include a control circuit 41 and/or a processing device 42. Application 43 may be a stand-alone software application or form a part of a software application that carries out additional tasks related to the mobile telephone 10. It will be apparent to a person having ordinary skill in the art of computer programming, and specifically in application programming for cameras, mobile telephones or other electronic devices, how to program a mobile telephone to operate and carry out logical functions associated with application 43. Accordingly, details as to specific programming code have been left out for the sake of brevity. Also, while the code may be executed by control circuit 41 in accordance with an exemplary embodiment, such controller functionality could also be carried out via dedicated hardware, firmware, software, or combinations thereof, without departing from the scope of the invention.

Mobile telephone 10 may also include a browser 60, such as a web browser for accessing the Internet or comparable network content. The web browser may be a stand-alone function as shown in the figure, or may be incorporated into another device function such as application 43.

Mobile telephone 10 has a display 14 viewable when the clamshell telephone is in the open position. The display 14 displays information to a user regarding the various features and operating state of the mobile telephone 10, and displays visual content received by the mobile telephone 10 and/or retrieved from the memory 45. As one aspect, the display 14 may display webpage content accessed with the browser 60 over the Internet or other network in which the mobile telephone operates. In addition to the display 14, the mobile telephone 10 may have additional or secondary displays, such as an external display viewable when the clamshell is in the closed position.

It will be appreciated that webpage and other network content may include text, still images, moving video images, and sound. The mobile telephone 10 also may include a media player 63. The media player 63 may be used to present audiovisual content to the user which may include images and/or sound together or individually, such as photographs or other still images, music, voice or other sound recordings, movies, mobile television content, news and information feeds, streaming audio and video, and the like. The audiovisual content may include accessed webpage content.

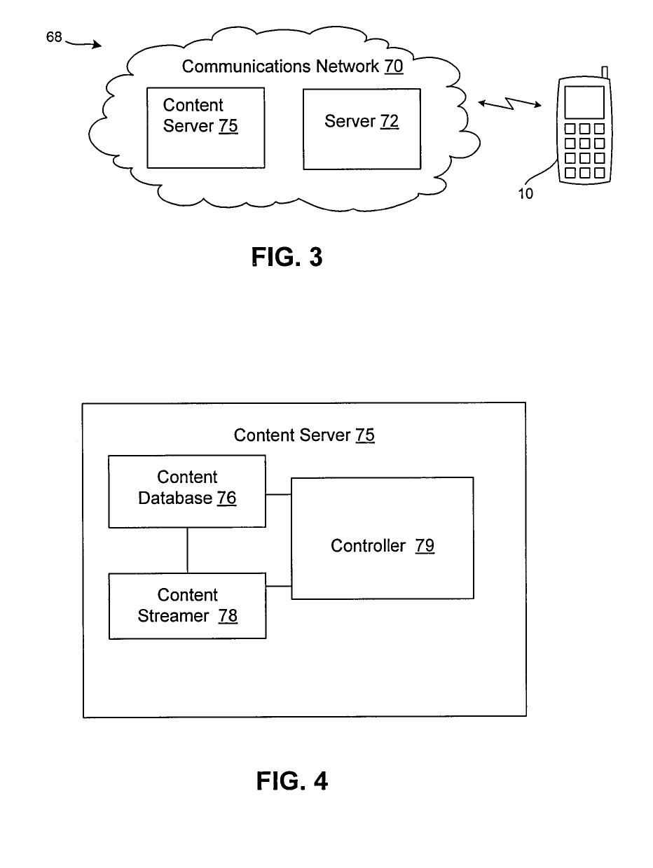

Referring to FIG. 3, the mobile telephone 10 may be configured to operate as part of a communications system 68. The system 68 may include a communications network 70 having a server 72 (or servers) for managing calls placed by and destined to the mobile telephone 10, transmitting data to the mobile telephone 10 and carrying out any other support functions. The server 72 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 70 may support the communications activity of multiple mobile telephones 10 and other types of end user devices. As will be appreciated, the server 72 may be configured as a typical computer system used to carry out server functions and may include a processor configured to execute software containing logical instructions that embody the functions of the server 72 and a memory to store such software.

Communications network 70 also may contain a content server 75 for providing webpage content to the mobile telephone 10. Content may be provided by any Internet service provider or network content provider as is conventional. FIG. 4 represents a functional block diagram of components of an exemplary content server 75. The content server 75 may include a webpage or content database 76 for storing a variety of webpage and other content. The content server also may include a controller 79 for carrying out and coordinating the various functions of the server. A user of an electronic device, such as mobile telephone 10, may access and download webpage and other content from the content database 76. In addition, content may be streamed to the electronic device by a content streamer 78 of the content server. Streamed content may include live broadcasts or feeds of news, entertainment, and/or other information.

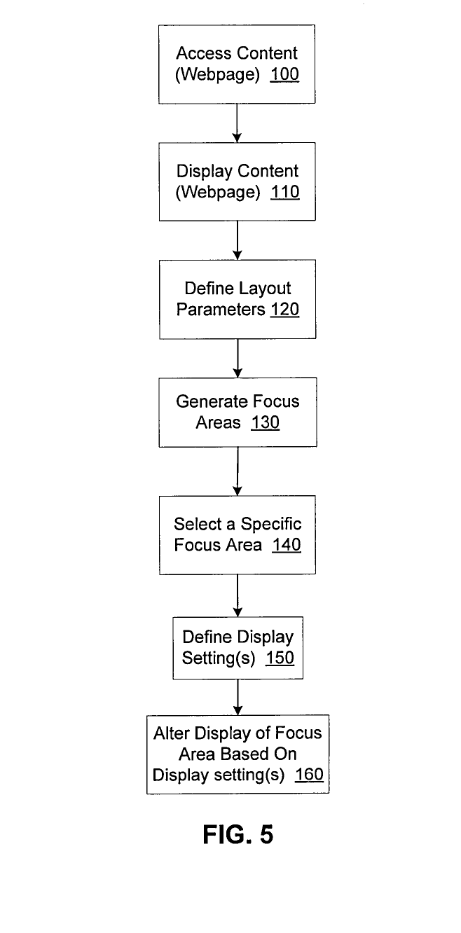

FIG. 5 is a flowchart representing an overview of an exemplary method of displaying content in an electronic device, and a portable electronic device in particular. Additional details regarding the steps of this overview are provided below in connection with example uses. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention. The method will be described by way of example in connection with the display of network content in the form of a webpage that a user may access over the Internet or other network. It will be appreciated that the method may be applied to other forms of content accessed by the electronic device.

The method may begin at step 100 at which the electronic device may access content, such as an Internet webpage or other content. The webpage may be accessed by any conventional means, such as with a dedicated key input or menu selection. At step 110, the webpage content may be displayed on a display of the electronic device.

At step 120, layout parameters may be defined for the content in the webpage. As further described in the examples below, the layout parameters may be thought of as setting the configuration of distinct or separate content portions within the webpage. The layout parameters thus may segment the webpage into a plurality of content portions, sometimes referred to herein as focus areas. The focus areas may be generated as portions of content related by subject matter, related by relative position on the display, or by some other criteria. The layout parameters may be defined by the content provider and embedded within the content or source code thereof. Alternatively or additionally, the layout parameters may be defined automatically by the electronic device or manually by the user. At step 130, a plurality of focus areas may be generated from the layout parameters, each focus area comprising a portion of the broader content contained in the webpage.

At step 140, a user may select a specific focus area from among the plurality of focus areas. The selected focus area may be one in which the user has a particular interest, but details of the focus may be difficult to ascertain due to the relatively small size of the typical display on a portable electronic device. Accordingly, at step 150 a user may define one or more display settings to be applied to the focus area. For example, the user may select to enlarge a focus area to span a substantially greater portion of the display. Another display setting may be to enlarge the font of text associated with the focus area, or enlarge images instead of text. Another display setting may be to highlight the focus area within the broader webpage. Another display setting may be to display the focus area on a dedicated or secondary display separate from the display of the broader webpage. Another display setting may be to increase the volume of or otherwise alter any audio content within the focus area. Another display setting may be to convey audio content within the focus area in a test-to-speech format, by converting the audio content to text and displaying the text. It will be appreciated that the potential display settings are myriad. In addition, various display settings may be combined to provide an enhanced display of the focus area. At step 160, the display of the focus area may be altered in accordance with the selected or defined display settings to provide an enhanced, more usable display of the focus area.

In this manner, an enhanced display of the focus area is provided to the user. Such enhanced display, therefore, may overcome or reduce the difficulties that typically may be associated with the small size of displays on portable electronic devices.

Additional details regarding the method of FIG. 5 may be understood by reference to particular examples. The examples described below are not meant to limit the scope of the invention, but rather are presented for explanatory purposes.

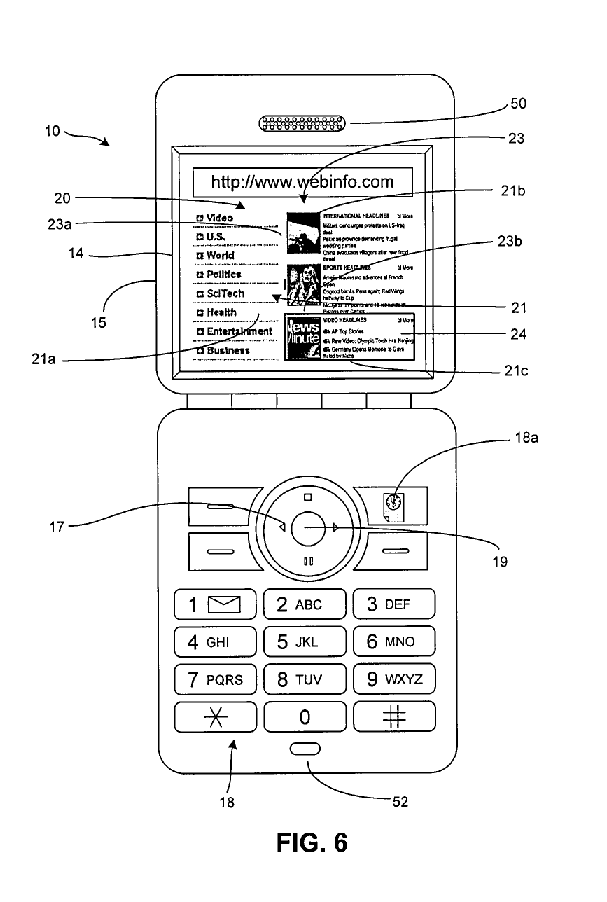

FIG. 6 depicts an exemplary webpage as it may be displayed on the display 14 of the mobile telephone 10. It will be appreciated that this specific webpage is an example, and its content may be varied. Mobile telephone 10 may include a keypad 18 that provides for a variety of user input operations. For example, keypad 18 typically includes alphanumeric keys for allowing entry of alphanumeric information such as telephone numbers, phone lists, contact information, notes, etc. In addition, keypad 18 typically includes special function keys such as a “send” key for initiating or answering a call, and others. Some or all of the keys may be used in conjunction with the display as soft keys, or as a touch screen.

Keypad 18 also may include a five-way navigational surface 17. The navigational surface 17 may include four directional surfaces and a center “select” button 19. As further described below, the navigational surface 17 may be used to navigate webpage content and select particular content items. In addition, as is also described below, the navigational surface 17 may be used to select features and settings associated with the display of webpage content. It will be appreciated that the navigational surface may have a variety of functions. For example, the navigational surfaces may embody controls for a media player such as play, stop, pause, and the like.

A user may access the Internet or comparable network content with the browser 60 (see FIG. 2) by any conventional means. For example, in FIG. 6 mobile telephone 10 has a dedicated key 18a for activating the browser function. Alternatively, the browser function may be selected from a menu displayed on the display 14. The mobile telephone 10 may then access network content, such as, for example, content downloaded or streamed from the content server 75 of FIG. 4.

In the example of FIG. 6, an exemplary news and information webpage 20 has been accessed from the Internet or other network. In one embodiment, the webpage content may include layout parameters 21 that include various selectable content items. As stated above, the layout parameters may be thought of as setting the configuration of distinct or separate content portions within the webpage. The layout parameters thus may segment the webpage into a plurality of content portions or focus areas. For example, on the left portion of the webpage 20, one layout parameter may segment a plurality of selectable news links 21a representing news categories that a user may access, such as Video, U.S., World, etc. Another example of a layout parameter 21b may segment one or more images and related text, as exemplified by the image of the soldier and the related text. Similarly, another layout parameter 21c may segment a series of related stories, such as the stories under the “video headlines” heading. Other layout parameters may be present as well to segment the webpage into content portions related by subject matter, function, location on the display, or other criteria as may be convenient.

In one embodiment, the layout parameters may be defined by the source code embedded within the webpage content itself. The layout parameters may be extracted automatically from the content, effectively dividing the webpage into portions of grouped subject matter. The automatic extraction of the layout parameters may be performed as one function of the webpage display application 43 (see FIG. 2).

In another embodiment, the layout parameters may not be contained within or otherwise retrievable from the webpage content. In this embodiment, webpage display application 43 may define the layout parameters automatically for the webpage. For example, as seen in FIG. 6, white spaces 23 may visually separate the various content portions from each other. In particular, white space 23a separates the news links from the rest of the webpage, white space 23b separates the video headlines, and so on. Application 43 may be configured to detect the various white spaces and define the layout parameters from such white spaces.

In another embodiment, the layout parameters may be user defined. For example, the display may be a touch screen, and the layout parameters may be drawn onto the webpage by a user with a stylus, finger, or other comparable input instrument. Application 43 may be configured to detect the user inputs and define the layout parameters from such inputs.

Regardless of how the layout parameters are defined, the focus areas may be generated within the webpage based on the layout parameters. For example, one focus area may be the news links, another focus area may be the video headlines, and so on. A user may select one of the focus areas for enhanced display. For example, the user may navigate the webpage from focus area to focus area using the navigational surface 17. In one embodiment, the system may permit focus area selection by voice command. In the example of FIG. 6, the user has navigated to a focus area 24 corresponding to the video headlines portion of the webpage, as indicated by the bold box around this portion of the webpage. The user may select a specific focus area for enhanced display with the select button 19 or by any other conventional means. The display of the selected focus area may be altered to provide enhanced visibility to the user.

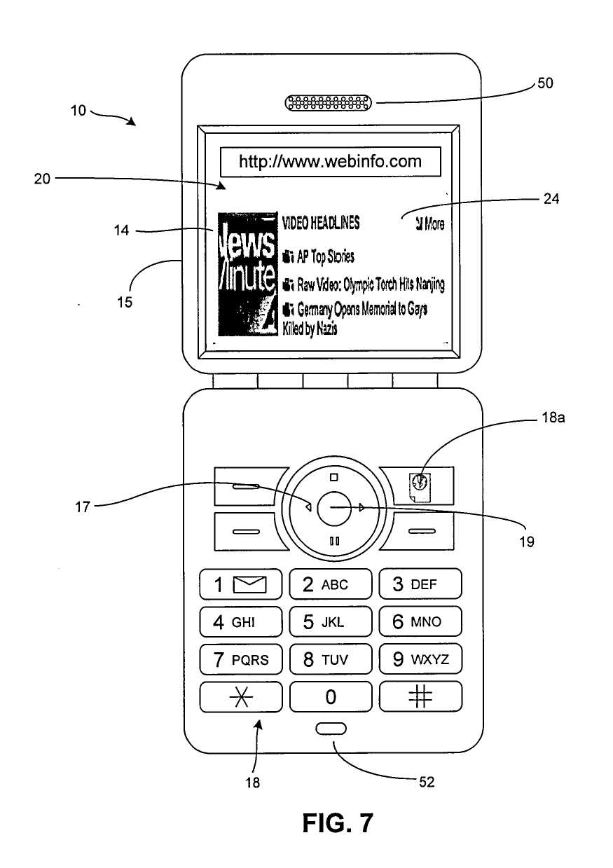

FIG. 7 depicts an exemplary display of the webpage depicted in FIG. 6 with one of the focus areas being selected by the user. In this example, the focus area corresponding to the video headlines portion of the webpage has been selected. The display of this focus area has been altered such that the focus area spans a significantly larger portion of the display. The images and text associated with the focus area are now more easily viewed by the user. In addition, a key on keypad 18 may be defined to provide a toggle function to switch between the display of the entire webpage and the display of the selected focus area.

It will be appreciated that other display enhancements may be employed other than enlarging the focus area. For example, the font of text in the focus area may be enlarged if the user desires more readable text as opposed to images. Alternatively, images within the focus area may be enlarged to the exclusion of text should the user desire more image-based navigation. The focus area also may be retained within the broader webpage, but highlighted to provide an enhanced view. Other display settings may be employed to provide for increased user customization of the display. In one embodiment, one of the display settings may be a default setting (e.g., enlarged display of the focus area), with the other settings being user definable or selectable options.

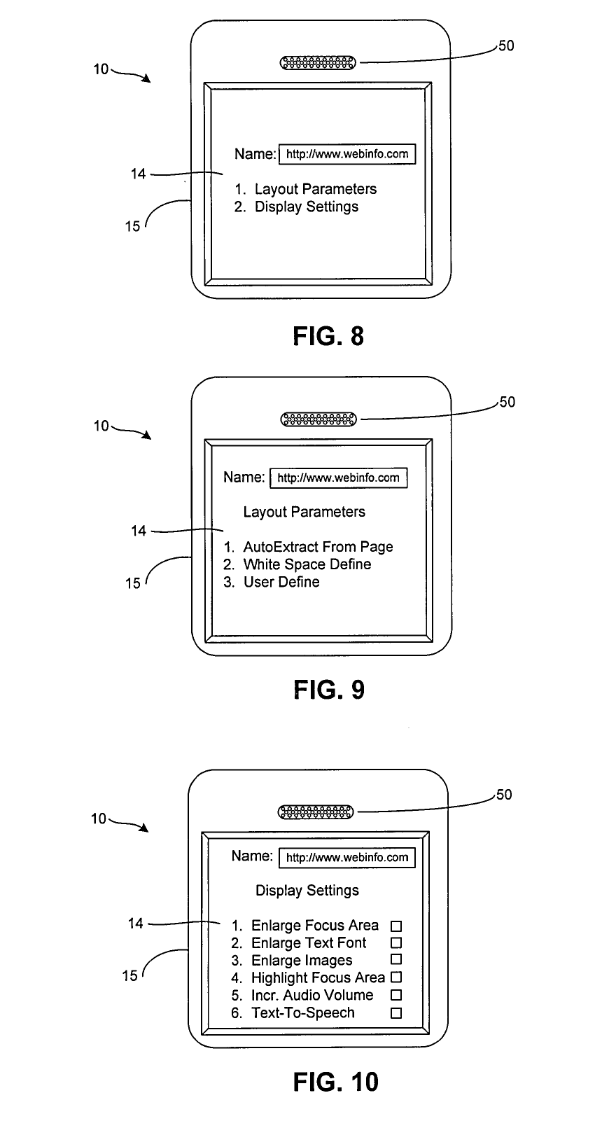

FIGS. 8-10 depict an exemplary graphical user interface and menu system for executing the webpage display application described herein. It will be appreciated that FIGS. 8-10 constitute examples, and other interfaces and menu systems may be employed. The user may navigate and select items from the menu screens with the keys of keypad 18, including the navigation surface 17 and select button 19.

FIG. 8 depicts an exemplary opening menu screen for a webpage display application, such as webpage display application 43. The application may be accessed with a dedicated key input, a selection from another menu, or by any conventional means. As another option, the application may execute automatically when a new webpage is downloaded or streamed to the electronic device. In this screen, the user may input a name for a webpage, which may be a network based identifier such as a URL, or a user may select a name manually. The user also may be provided with options for defining layout parameters and display settings for the particular webpage.

FIG. 9 depicts an exemplary menu for defining layout parameters for the current webpage. As described above, layout parameters may be extracted from the content itself (referred to in the figure as “AutoExtract From Page”), generated automatically based on white spaces gleaned from the webpage, or defined manually by a user. FIG. 10 depicts an exemplary menu for defining display settings for a selected focus area from within the webpage. As described above, display settings may include such items as enlarging the focus area, enlarging the font of text in the focus area, enlarging images in the focus area, highlighting the focus area within the webpage, increasing the volume of audio content in the focus area, or conveying audio content in a text-to-speech format. In the exemplary display settings menu, check boxes are provided which may permit a user to select multiple display settings for the focus areas of the current webpage.

In one embodiment, one or more of the layout parameters and/or display settings may be set as default settings. If a user simply desires to use the default settings, menu screens exemplified by FIGS. 8-10 need not be accessed at all, providing a way for the user to utilize the webpage display application with little or no effort.

It will be appreciated that the above embodiments provide examples of ways by which a user may define, select, and store layout parameters and/or display settings. These examples are not meant to limit the scope of the invention, and other schemes may be employed.

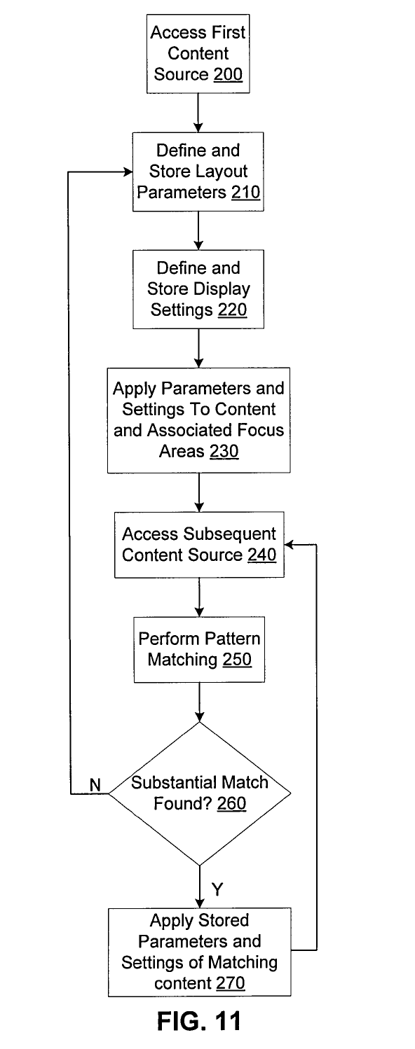

In one embodiment, layout parameters and display settings may be stored in a memory, such as the memory 45 shown in FIG. 2. The stored parameters and settings may be applied to the same or similar content accessed at some future time. FIG. 11 is a flowchart representing an exemplary method of sequentially displaying multiple content sources, such as a plurality of webpages. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

Referring to FIG. 11, the method may begin at step 200 in which a first content source is accessed. The first content source may be a webpage or similar as described above. Because it is presumed in this example that the accessed content is a first content, there currently would be no stored settings. Accordingly, at step 210 layout parameters may be defined and stored. As described above, the layout parameters may be extracted from the content itself, defined automatically by a program or application stored within the electronic device, or be user defined. At step 220, display settings as described above may be defined and stored which may apply to one or more focus areas segmented within the content. As before, the display settings may be default settings within the program or application, or user defined. At step 230, the parameters and settings may be applied to the webpage and focus areas therein in the manner described above.

At step 240, a user may access a subsequent or additional content source, which may or may not be comparable to the first content source. At steps 250 and 260, a pattern matching function may be performed to determine whether the currently accessed content is comparable to or substantially matches previously accessed content for which layout parameters and display settings are stored. It will be appreciated that two accessed webpages, even provided by the same content provider, will rarely be exactly the same. For example, news and information webpages are nearly continuously altered to provide updates on reported events, add new events, delete old events, and the like. The purpose of the pattern matching, therefore, is to determine whether the currently accessed content is comparable in layout to previously accessed content. In one embodiment, the pattern matching essentially may comprise a comparison of layout parameters, with partial or minimal regard to the specific content. It is reasonable to presume that two webpages having a comparable layout would tend to accommodate comparable focus area designations.

The pattern matching of step 250 may proceed based on a variety of criteria to determine whether currently accessed content substantially matches previously accessed content. The pattern matching may compare characteristics including the webpage identity (such as a URL or other identity), layout parameters, white space configuration, content headings and similar general content features, and others. Based on such comparisons, at step 260 a determination may be made as to whether the currently accessed content (webpage) substantially matches a previously accessed content (webpage) for which layout parameters and display settings are stored. If a substantial match is found, at step 270 the stored layout parameters and/or display settings may be applied to the newly accessed content. In one embodiment, the application of the stored parameters and settings may be partial, with the device application 43 being configured to adjust the layout parameters and display settings to accommodate minor differences between the currently accessed and matched previously accessed content. In this manner, the layout parameters and display settings may be set only once for comparable content, thereby reducing the user effort in enhancing webpage display. If at step 260 a substantial match is not found, then the method may return to step 210. Layout parameters and display settings may then be defined and stored for the newly accessed content, which may provide additional bases for comparisons to content accessed in the future. As indicated by the arrow following step 270, the method may be executed repeatedly whenever the browser is used to access varying webpages, whether as part of a single browsing session or across numerous discontinuous browsing sessions.

The current invention, therefore, has several advantages over current systems for displaying webpages and similar content on a portable electronic device. A user at least initially may view the entirety of the content without the truncation common in conventional display systems. In this vein, both text and images may be displayed, in contrast to the text-only or image-only conversion systems. Should the user have a particular interest in a certain portion of the webpage, a user may select a focus area containing such portion for enhanced display. User-defined layout parameters and display settings may provide customization. In addition, by storing layout parameters and display settings, the parameters and settings may be applied to the same or comparable webpages accessed in the future. A user, therefore, need not continually define or adjust the various display settings. The system and methods of the current invention, therefore, provide a convenient and enhanced display of content on a portable electronic device as compared to current systems.

Referring again to FIGS. 1 and 2, additional features of the mobile telephone 10 will now be described. For the sake of brevity, generally conventional features of the mobile telephone 10 will not be described in great detail herein. The mobile telephone 10 includes call circuitry that enables the mobile telephone 10 to establish a call and/or exchange signals with a called/calling device, typically another mobile telephone or landline telephone, or another electronic device. The mobile telephone 10 also may be configured to transmit, receive, and/or process data such as text messages (e.g., colloquially referred to by some as “an SMS,” which stands for short message service), electronic mail messages, multimedia messages (e.g., colloquially referred to by some as “an MMS,” which stands for multimedia message service), image files, video files, audio files, ring tones, streaming audio, streaming video, data feeds (including podcasts) and so forth. Processing such data may include storing the data in the memory 45, executing applications to allow user interaction with data, displaying video and/or image content associated with the data, outputting audio sounds associated with the data and so forth.

The mobile telephone 10 may include an antenna 44 coupled to a radio circuit 46. The radio circuit 46 includes a radio frequency transmitter and receiver for transmitting and receiving signals via the antenna 44 as is conventional. The mobile telephone 10 further includes a sound signal processing circuit 48 for processing audio signals transmitted by and received from the radio circuit 46. Coupled to the sound processing circuit 48 are a speaker 50 and microphone 52 that enable a user to listen and speak via the mobile telephone 10 as is conventional.

The display 14 may be coupled to the control circuit 41 by a video processing circuit 54 that converts video data to a video signal used to drive the various displays. The video processing circuit 54 may include any appropriate buffers, decoders, video data processors and so forth. The video data may be generated by the control circuit 41, retrieved from a video file that is stored in the memory 45, derived from an incoming video data stream received by the radio circuit 48 or obtained by any other suitable method.

The mobile telephone 10 also may include a local wireless interface 66, such as an infrared transceiver and/or an RF adaptor (e.g., a Bluetooth adapter), for establishing communication with an accessory, another mobile radio terminal, a computer or another device. For example, the local wireless interface 66 may operatively couple the mobile telephone 10 to a headset assembly (e.g., a PHF device) in an embodiment where the headset assembly has a corresponding wireless interface.

The mobile telephone 10 also may include an I/O interface 56 that permits connection to a variety of I/O conventional I/O devices. One such device is a power charger that can be used to charge an internal power supply unit (PSU) 58. The mobile telephone may include additional functions such as, for example, a camera 62, a position data receiver 67, and others.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. An electronic device comprising:
a browser for accessing content;
a display for displaying the content;
a controller for generating a plurality of focus areas within the content, each focus area comprising a portion of the content; and
an input device for receiving a selection of a focus area from among the plurality of focus areas;
wherein the controller is further configured to receive the selection from the input device and alter the display of the selected focus area.

2. The electronic device of claim 1, wherein the content includes a plurality of layout parameters, and the controller is configured to generate the plurality of focus areas from the layout parameters of the content.

3. The electronic device of claim 2, wherein the input device receives an input of at least one display setting, and the controller is configured to alter the display of the selected focus area in accordance with the inputted display setting.

4. The electronic device of claim 3, wherein the at least one display setting is at least one of highlighting the focus area, enlarging the focus area, altering the font of text within the focus area, enlarging an image within the focus area, adjusting the volume of audio content within the focus area, and conveying audio content within the focus area in a text-to-speech format.

5. The electronic device of claim 3, further comprising a memory for storing the plurality of layout parameters and the at least one display setting.

6. The electronic device of claim 5, wherein the content is a first content and the browser accesses a second content,
wherein the controller is further configured to determine whether the second content substantially matches the first content, and if so, apply the stored layout parameters and stored at least one display setting to the second content.

7. The electronic device of claim 2, wherein the plurality of the layout parameters are embedded in the content as accessed by the browser, and the controller is configured to generate the plurality of focus areas by extracting the layout parameters from the content.

8. The electronic device of claim 2, wherein the controller is configured to define the plurality of layout parameters from the configuration of the content, and to generate the plurality of focus areas from the defined layout parameters.

9. The electronic device of claim 8, wherein the controller is configured to define the layout parameters from white spaces that separate portions of the content.

10. The electronic device of claim 2, wherein the input device receives inputs from a user defining the plurality of layout parameters, and the controller is configured to generate the plurality of focus areas from the inputted layout parameters.

11. The electronic device of claim 1, wherein the controller is configured to alter the display of the selected focus area by at least one of highlighting the focus area, enlarging the focus area, altering the font of text within the focus area, enlarging an image within the focus area, adjusting the volume of audio content within the focus area, and conveying audio content within the focus area in a text-to-speech format.

12. The electronic device of claim 1, wherein the electronic device is a mobile telephone.

13. A method of displaying content in an electronic device comprising the steps of:
accessing content;
displaying the accessed content on a display;
generating a plurality of focus areas within the content, wherein each focus area comprises a portion of the content;
receiving a selection of a focus area from among the plurality of focus areas; and
altering the display of the selected focus area.

14. The method of claim 13, wherein the altering step comprises at least one of highlighting the focus area, enlarging the focus area, altering the font of text within the focus area, enlarging an image within the focus area, adjusting the volume of audio content within the focus area, and conveying audio content within the focus area in a text-to-speech format.

15. The method of claim 13, wherein the generating step comprises defining a plurality of layout parameters within the content, and generating the plurality of focus areas from the layout parameters.

16. The method of claim 15, wherein the altering step includes receiving an input of at least one display setting from an input device, and altering the display of the selected focus area in accordance with the inputted display setting.

17. The method of claim 16, further comprising storing the plurality of layout parameters and storing the at least one display setting in a memory.

18. The method of claim 17, wherein the content is a first content, and the method further comprises:
accessing a second content,
determining whether the second content substantially matches the first content, and if so,
applying the stored layout parameters and stored at least one display setting to the second content.

19. The method of claim 15, wherein the plurality of the layout parameters are embedded in the accessed content, and the generating step comprises extracting the layout parameters from the content and generating the plurality of focus areas from the extracted layout parameters.

20. The method of claim 15, wherein the generating step comprises defining a plurality of layout parameters from white spaces separating portions of the content, and generating the plurality of focus areas from the defined layout parameters.
